(19) United States
(12) Patent Application Publication
(10) Pub. No.: US 2012/0290560 A1
(43) Pub. Date: Nov. 15, 2012

(54) MECHANISM FOR EFFICIENTLY QUERYING APPLICATION BINARY INTERFACE/APPLICATION PROGRAMMING INTERFACE-RELATED INFORMATION

(76) Inventor: Kushal Das, Pune (IN)

(21) Appl. No.: 13/107,614

(22) Filed: May 13, 2011

(51) Int. Cl. G06F 17/30

(52) U.S. Cl. 707/722; 707/769; 707/E17.014

(57) ABSTRACT

A method for efficiently querying application binary interface/application programming interface-related information may include obtaining a binary file relating to a software package of an operating system, and extracting, from the binary file, interface details relating to interfaces associated with the software program. The method may further include receiving a user query requesting query-specific interface details that are particular to an interface of the interfaces noted in the user query, extracting the query-specific interface details from the interface details, and generating a response to the user query. The response includes the query-specific interface details.

### TECHNICAL FILED

The embodiments of the invention relate generally to software compatibility and, more specifically, relate to providing a mechanism for efficiently querying application binary interface (ABI)/application programming interface (API)-related information.

### BACKGROUND

Multiple software programs that run on a computing device often share libraries provided by the based operating system employed at the computing device. For example, these shared libraries can be used by software programs to access various functions (e.g., library or operating system functions, such as reading files, writing files, file management, network communications, inter-process communications, memory management, string manipulations, user interface manipulations, mathematics functions, etc.). Typically, these shared libraries change when the operating system changes; for example, upgrading to a newer version of an operating system can change the functions presented in one or more shared libraries, change versions and arguments used in these functions, and/or change functionalities of some, none or all of the library functions. As a result, a software program developed for one operating system may not work on another operating system and, similarly, upgrading to the new operating system may cause a software program not to work on the new or updated operating system. To determine whether a software program is executable on a new or updated operating system, the software program is typically re-compiled to run on the new or updated operating system.

The aforementioned re-compiling and re-running of the software program is further complicated when numerous changing shared libraries in multiple software programs are involved. One way to contain this complexity is to employ a team of software developers to download the source code of each operating system having various software programs and manually inspect each ABI/API associated with each shared library of each software program of each operating system for ABI/API breaks and/or changes. Another way is for a bunch of software developers to tediously investigate various debugging reports associated with each ABI/API. However, since not all dependencies of ABIs/APIs may be known to a software developer, these review processes simply turn out to be long and complex processes that often fall short of revealing all the significant data and/or relevant material. Further, these review/investigation processes are extremely inefficient in terms of cost and labor, mainly due to the limited information they reveal and their manual nature and susceptibility to human errors.

### BRIEF DESCRIPTION OF THE DRAWINGS

The invention will be understood more fully from the detailed description given below and from the accompanying drawings of various embodiments of the invention. The drawings, however, should not be taken to limit the invention to the specific embodiments, but are for explanation and understanding only.

FIG. 1 illustrates a host machine employing an application binary interface/application programming interface query response mechanism according to one embodiment of the invention;

FIG. 2 illustrates an application binary interface/application programming interface query response mechanism according to one embodiment of the invention;

FIG. 3 illustrates a method for efficiently querying application binary interface/application programming interface-related information according to one embodiment of the invention; and

FIG. 4 illustrates a computing system according to one embodiment of the invention.

### DETAILED DESCRIPTION

Embodiments of the invention that provide a mechanism for efficiently querying application binary interface/application programming interface-related information are described. A method of embodiments of the invention includes obtaining a binary file relating to a software package of an operating system, and extracting, from the binary file, interface details relating to interfaces associated with the software program. The method may further include receiving a user query requesting query-specific interface details that are particular to an interface of the interfaces noted in the user query, extracting the query-specific interface details from the interface details, and generating a response to the user query. The response includes the query-specific interface details.

Embodiments of the present invention are provided for efficiently querying ABIs/APIs-related information. In one embodiment, a mechanism is provided to extract and store metadata and other relevant information (e.g., provisioning details, usage details, etc.) about ABIs/APIs to allow users (e.g., software developers, system administrators, etc.) to receive responses to their queries (regardless of their complexity) about any of the ABIs/APIs (e.g., malloc@GLIB_{—}2.0, etc.) relating to various shared libraries (e.g., libc.so.6, etc.) within multiple software packages (e.g., Red Hat Package Manager (“RPM Package Manager”—a recursive acronym), etc.) of any number of operating systems (Red Hat Enterprise Linux, etc.). Being based on metadata and ABI/API provisioning and usage details, makes ABI/API-related query responses intelligent, reliable, and complete and eliminates the need for employing an entire team of software developers to manually review debugging reports and/or investigate operating system source codes. ABI/API metadata, provisioning details, and usage details are collectively referred to herein as “ABI/API details”.

For example, a user may query certain information about an ABI/API to study an existing error relating to the ABI/API, introduce a change to (including deletion of) the ABI/API, add a new ABI/API to improve a future version of an operating system, etc. Having query responses based on ABI/API provisioning/usage data and relevant metadata allows a user to know, understand, and appreciate the existing ABIs/APIs in order to prevent potential errors (to be encountered by a customer) by making necessary changes to the existing ABIs/APIs (at the provider's end) prior to releasing a future version of an operating system to a customer. These query responses may be provided to users in any number of formats, such as Portable Document Format (PDF), Open Document Format (ODF), plain text, graph, chart, etc.

As will be discussed throughout this document, a provider refers to a company or organization responsible for creating and providing a base operating system, local software programs, shared libraries, etc., while a customer refers to a third-party company or organization responsible for generating and providing third-party software programs that access and use the provider-based ABIs/APIs and their shared libraries. Further, these ABIs/APIs and the shared libraries may be accessed and used by one or more local software programs that are part of the base operating system and independent of one or more third-party software programs. Embodiments of the invention are applicable to ABIs and/or APIs and as such the term “ABI(s)/API(s)”, used throughout this document, refers to ABI(s) and/or API(s).

An ABI represents a low-level interface between a software program and an operating system or another software program. An ABI represents a compiled binary form of a library or operating system function (“function”) (e.g., printing files, deleting files, reading files, writing files, file management, network communications, inter-process communications, memory management, string manipulations, user interface manipulations, mathematics functions, etc.) serving as a low-level interface between local and third-party software programs and the base operating system. When a function is broken, such as a print function (e.g., when a print command executes double prints or does not print the entire text (e.g., prints “hell” when asked to print “hello”)), etc., the broken function indicates a possible problem with the corresponding ABI and its corresponding shared library. An API serves as an interface between various software programs and facilitates interactions between them, while representing a particular set of rules and specifications that a software program can follow to access and make use of the services and resources provided by another particular software program that implements that API. ABIs/APIs refer to and may include data-identifying ABIs and/or APIs, such as those providing and covering various details, such as data types, sizes, alignments, identification names and other unique identifications, symbol versions, system call numbers, binary format of object files, locations, versions, calling conversations, etc.

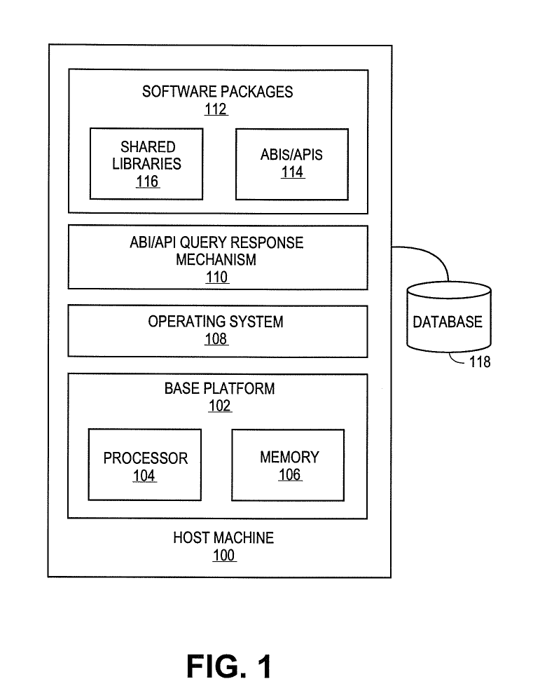

FIG. 1 illustrates a host machine 100 employing an ABI/API query response mechanism 110 according to one embodiment of the invention. Host machine 100 includes a base platform 102 that comprises a computing platform, which may be capable of, for example, working with a standard operating system 108. Operating system 108 serves as an interface between any hardware or physical resources of the host machine 100 and a user. In some embodiments, base platform 102 may include processors 104, memory devices 106, network devices, drivers, and so on. Host machine 100 may include a server computing system or a client computing system. It is to be noted that terms like “machine”, “device”, “computer”, and “computing system” are used interchangeably and synonymously throughout this document.

In one embodiment, the host machine 100 employs the ABI/API query response mechanism 110 (“query mechanism”) to facilitate extracting of ABI/API details (including metadata, provisioning details, and usage details) relating to ABIs/APIs 114 associated with shared libraries 116. The ABI/API details may be extracted by scanning binary files corresponding to software packages 112 of multiple operating systems. These binary files may be accessed at and obtained from a database 118, and the extracted ABI/API details may then be sorted and stored at the same database 118 or another storage medium. The ABI/API details stored at the database 118 may then be accessed and used by the query mechanism 110 to respond to various ABI/API-related user queries submitted by a user (e.g., software developer, system administrator, etc.). In response to the user queries, the query mechanism 110 accesses and obtains the relevant parts of the stored ABI/API details and, using the relevant details, prepares appropriate responses to the user queries. The responses are then provided to the user.

The ABI/API details, in one embodiment, include ABI/API usage details that provide usage information of various ABIs and/or APIs 114 being accessed and used by their associated shared libraries 116 relating to each of the software packages 112 (including local and third-party software packages). For example, depending on the importance of a particular function (e.g., printing files, deleting files, reading files, writing files, file management, network communications, inter-process communications, memory management, string manipulations, user interface manipulations, mathematics functions, etc.) to a software package 112, an ABI/API 114 associated with that particular function would be expected to be frequently accessed and used by that software package 112; hence, indicating the (usage-based) importance of the ABI/API 114 and its associated shared library 116. Typically, a high-usage ABI/API may be regarded as more important than its other less-frequently used ABIs/APIs of the available ABIs/APIs 114. However, for example, certain large and often-used libraries (e.g., glibc) may be regarded as important, but their ABI/API usage details may reveal that a relatively small and rarely-used library (e.g., lib.b.2, libfreedom, etc.) may be more important to a particular customer based on the customer's third-party software program's use of that small library.

The ABI/API details may further include ABI/API provisioning details, such as a list of ABIs/APIs 114 and their corresponding shared libraries 116 and software packages 112, a list of known uses of ABIs/APIs 114, a list of functions associated with each ABI/API 114 and the importance of each function, etc.

In one embodiment, the extracted ABI/API details further include relevant ABI/API metadata that reveals release-versions of ABIs/APIs 114 (e.g., strstr@GLIB_{—}2.0, 3.0, etc.), release-versions of software packages (e.g., RPM 4.0, 5.0, etc.) and their operating systems (e.g., RHEL 5.0, 6.0, etc.), ABI/API dependencies (e.g., ABI A depends from ABI C that depends from ABIs X and Y, and so on), names of persons or development team or department (e.g., John Smith et al., Czech software development team, etc.) associated with various ABIs/APIs 114 (e.g., a team of software developers responsible for developing, maintaining, storing, etc., of source codes of various ABIs/APIs 114), identifying changes (e.g., adding, removing, editing, etc., a function relating to an ABI/API) made to existing ABIs/APIs 114, listing proposed changes to existing ABIs/APIs 114 (e.g., changes requesting by a customer), and the like.

Once a user query (e.g., find all relevant details about an ABI strstr@GLIB_{—}2.0 within operating system RHEL 5.0) is received from a user, the data request contained within the user query is appropriately matched with the stored ABI/API details (e.g., information relating to RHEL 5.0 is accessed and reviewed) and any relevant details (e.g., the requested ABI/API details relating to strstr@GLIB_{—}2.0 within RHEL 5.0) are extracted from the ABI/API details. The extracted pertinent ABI/API details are then provided back to the user within as a response to the user query.

Shared libraries 116 and the related ABIs/APIs 114 may be accessed and used by any number of local and/or third-party software packages 112 that are employed by any number of operating systems (e.g., a typical operating system may contain 2000-3000 software packages). As aforementioned, an ABI/API 114 refers to or includes data-identifying ABIs and/or APIs, such as those providing and covering details, such as data types, sizes, alignments, identification names and other unique identifications, symbol versions, system call numbers, binary format of object files, locations, versions, calling conversations, etc.

A shared library 116 represents a collection of classes and subroutines that are used to develop and support software packages 114, such as representing code and data that provide services to software packages 114. Each shared library 116 provides a collection or group of ABIs/APIs 114. A third-party software package of software packages 112 represents a software program that is, at least partly, developed by an organization other than the provider that produces the operating system 108; for example, a third-party software program may include a special-purpose software program that is used for or by an organization (e.g., media development software for media companies, specialized modeling software, etc.) and, like a local software program, accesses and uses any number of shared libraries 116 to utilize various operating system functions.

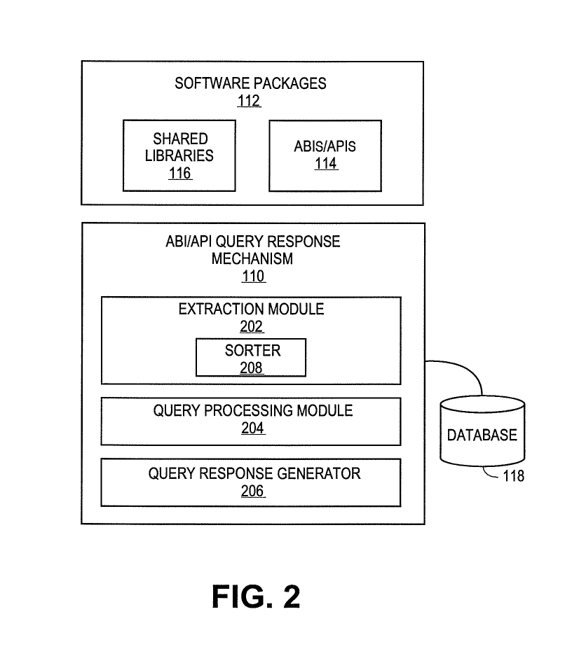

FIG. 2 illustrates an ABI/API query response mechanism 110 according to one embodiment of the invention. In one embodiment, the query mechanism 110 includes an extraction module 202 to scan or monitor software packages 112 to extract ABI/API details (e.g., usage details, provisioning details, and metadata) about ABIs/APIs 114. For example, the extraction module 202 performs in-between checks of the ABIs/APIs 114, periodically or on-demand, to obtain binary files associated with each ABI/API 114. These binary files may be obtained from a database 118 and are then probed, by the extraction module 202, to extract the ABI/API details relating to each ABI/API 114 associated with various shared libraries 116 of the software packages 112. The extracted ABI/API details may then be stored back at the same database 118 that is part of or connected to a host machine where the query mechanism 110 is employed or another database or storage medium that is part of or connected to a remote machine that is in communication with the host machine.

In one embodiment, the extraction module 202 may further include a sorter 208 to sort the ABI/API details stored at the database 118. For example, the ABI/API details may be sorted automatically or as requested by the user, such as in chronological order (based on the data and time each ABI/API 114 was generated and/or added to one of the software packages 112), ascending or descending order based on the number of changes made to each ABI/API (e.g., the ABI/API with the most updates so far is listed first and so on, and vice versa), alpha-numeric order of names and/or version numbers of the software packages 112 and/or their operating systems, and the like. This sorting of the ABI/API details may be used by a query processing module 204 of the query mechanism 110 to process the ABI/API details in response to user queries.

In one embodiment, the query processing module 204 may review the content contained within the user query and compare or match the content to the ABI/API details at the database 118. For example, in response to a user query requesting a list of all ABIs/APIs of the ABIs/APIs 114 associated with a particular shared library (e.g., libfoo.so) of the shared libraries 116, the query processing module 204 accesses the ABI/API details at the database 118 and seeks each ABI/API associated with the requested shared library. For example, the query processing module 204 may use the shared library-based sorting (e.g., alpha-numeric sorting) of the ABI/API details to, first, find the requested shared library in the sorted list of shared libraries 116 and, second, extract the names of each ABIs/APIs corresponding to the requested shared library. In one embodiment, a query response generator 206 of the query mechanism 110 then generates a response having a list of the extracted ABI/API names and provides the response to the user. If, for example, a user query requests more information than simply a list of ABI/API names (e.g., names of software developers responsible for programming an ABI/API), the various modules 202-208 of the query mechanism 110 are capable of extracting and processing the requested information and then providing it to the user via a response (e.g., the response having a list of software developer names responsible for developing the ABI/API). Having this additional information may allow the user to take various appropriate measures (e.g., contact the original software developer) to have errors corrected or improvements made to the ABI/API. A query response may be generated and provide in any format (e.g., PDF, ODF, text, graph, etc.) and displayed using a display device.

It is contemplated that the query mechanism 110 is capable of addressing user queries of various levels of complexity by processing them using the extracted and stored ABI/API details and generating and providing appropriate responses to users. For example, a user may place a query that requests certain ABI/API details (e.g., ABI/API dependencies, ABI/API updates, ABI/API development dates, etc.) about a particular ABI/API (e.g., strstr@GLIB_{—}2.0) for one or more operating system (e.g., RHEL 4.0, RHEL 5.0, etc.), and the like. Once a query response has been generated and provided back to the user, the user may use the information contained in the response to, for example, have a software developer make changes to the requested ABI/API, strstr@GLIB_{—}2.0, to fix an error or make an improvement (e.g., add a printing function) for a future release (e.g., release 6.0) of the relevant operating system. As aforementioned, a user query of any level of complexity can be placed, such as which one of the software packages 112 uses ABI malloc@GLIB_{—}2.0 associated with shared library libc.so.6 in operating systems RHEL 4.0 and RHEL 5.0, etc.

Without having the benefit of intelligent and resourceful query responses based on relevant ABI/API details associated with each ABI/API 114 as provided by the query mechanism 110, a team of software developers may be required to manually review source codes of software packages 114 or contents of relevant debugging reports, etc., and may still fail to discover the necessary information relating to particular ABIs/APIs 114. However, having an intelligent and resourceful query response allows a user to address and correct ABI/API-related errors or reprogram or upgrade the ABIs/APIs 114 on the provider's end, saving the potential customers from encountering ABI/API-related failures.

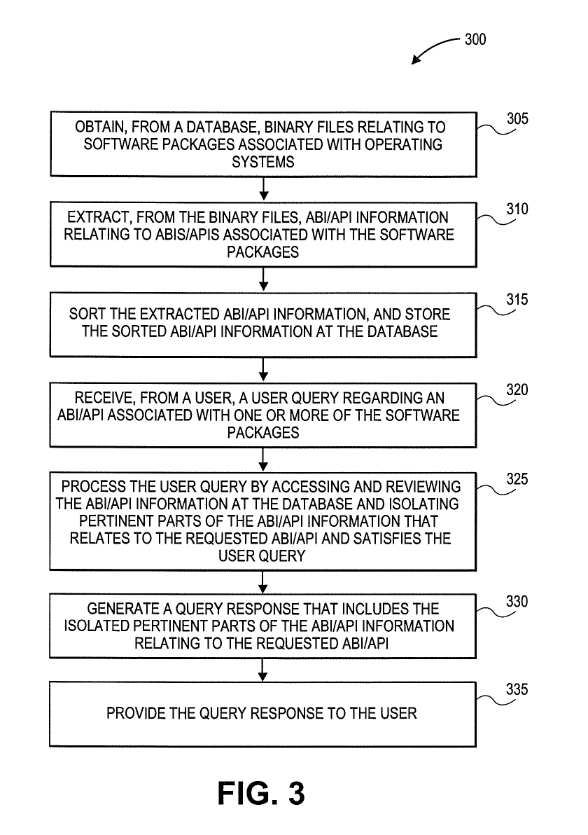

FIG. 3 illustrates a method for efficiently querying application binary interface/application programming interface-related information according to one embodiment of the invention. Method 300 may be performed by processing logic that may comprise hardware (e.g., circuitry, dedicated logic, programmable logic, microcode, etc.), software (such as instructions run on a processing device), or a combination thereof, such as firmware or functional circuitry within hardware devices. In one embodiment, method 300 is performed by ABI/API query response mechanism 110 of FIG. 1.

Method 300 starts at block 305 with accessing and obtaining binary files relating to software packages associated various operating systems. These binary files may be obtained from a database in communication with a computing system employing the query mechanism. At block 310, ABI/API details (including ABI/API usage details, provisioning details, and metadata) relating to each ABI/API of the software packages are detected and extracted from the obtained binary files. At block 315, these ABI/API details are sorted (according to a predetermined sort pattern or as requested by a user) and then stored at the same database as the one from where the binary files were obtained or at another remote database or storage medium in communication with the computing system.

At block 320, a user query regarding an ABI/API of a software package is received from a user. The user query may be of any level of complexity and request any form, level, or amount of information regarding any number of ABIs/APIs associated with any number of software packages contained within any number of operating systems. At block 325, the user query is processed by accessing and reviewing the ABI/API details in order to isolate and extract those parts of the ABI/API details that are pertinent to the ABI/API that is requested in the user query. In one embodiment, the sorting of the ABI/API details at the database may be used by the query mechanism to properly and accurately isolate and extract the relevant ABI/API details.

At block 330, a response to the user query is generated. In one embodiment, the response includes the extracted ABI/API details pertinent to the requested ABI/API in the form and manner requested by user and as provided in the user query. At block 335, the query response is provided to the user so that the user may have a precise, intelligent, and resourceful response relating to the requested ABI/API. The user may choose to review contents of the response and subsequently, edit, move, delete, etc., the requested ABI/API (or ABIs/APIs related to the requested ABI/API) or add one or more new ABI/APIs, accordingly.

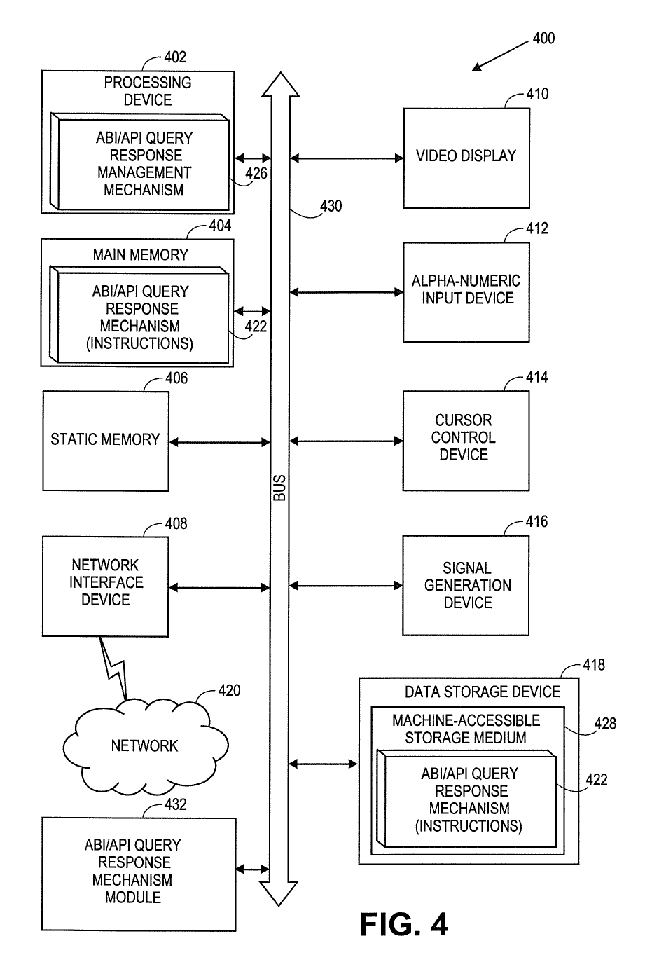

FIG. 4 illustrates a computing system 400 employing an ABI/API query response mechanism according to one embodiment of the invention. Within the computing system 400 is a set of instructions for causing the machine to perform any one or more of the methodologies discussed herein. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computing system 400 includes a processing device 402, a main memory 404 (e.g., read-only memory (ROM), flash memory, RAM, dynamic RAM (DRAM) such as synchronous DRAM (SDRAM), DRAM (RDRAM), etc.), a static memory 406 (e.g., flash memory, static random access memory (SRAM), etc.), and a secondary memory 418 (e.g., a data storage device in the form of a drive unit, which may include fixed or removable machine-accessible or computer-readable storage medium), which communicate with each other via a bus 430.

Processing device 402 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 402 may also be one or more special-purpose processing devices such as an application specific integrated circuit (ASIC), a field programmable gate array (FPGA), a digital signal processor (DSP), network processor, or the like. Processing device 402 is configured to execute the processing logic 426 for performing the operations and methods discussed herein.

The computing system 400 may further include a network interface device 408. The computing system 400 also may include a video display unit 410 (e.g., a liquid crystal display (LCD) or a cathode ray tube (CRT)) connected to the computing system through a graphics port and graphics chipset, an alphanumeric input device 412 (e.g., a keyboard), a cursor control device 414 (e.g., a mouse), and a signal generation device 416 (e.g., a speaker).

The data storage device 418 may include a non-transitory machine-accessible storage medium (or a non-transitory computer-readable storage medium) 428 on which is stored one or more sets of instructions 422 (e.g., ABI/API query response mechanism) embodying any one or more of the methodologies or functions described herein. The ABI/API query response mechanism may also reside, completely or at least partially, within the main memory 404 (e.g., ABI/API query response mechanism (instructions) 422) and/or within the processing device 402 (e.g., ABI/API query response mechanism (processing logic) 426) during execution thereof by the computing system 400, the main memory 404 and the processing device 402 also constituting a non-transitory machine-readable storage media. Further, for example, ABI/API query response mechanism instructions 422 may be transmitted or received over a network 420 via the network interface device 408.

The non-transitory machine-readable storage medium 428 may also be used to store the ABI/API query response mechanism (instructions) 422 persistently. While the machine-accessible storage medium 428 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the present invention. The term “machine-accessible storage medium” shall accordingly be taken to include, but not be limited to, solid-state memories, and optical and magnetic media.

ABI/API query response mechanism modules 432, components and other features described herein (for example in relation to FIG. 1) can be implemented as discrete hardware components or integrated in the functionality of hardware components such as ASICS, FPGAs, DSPs or similar devices. In addition, the modules 432 can be implemented as firmware or functional circuitry within hardware devices. Further, the modules 432 can be implemented in any combination hardware devices and software components.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “extracting”, “detecting”, “probing”, “parsing”, “comparing”, “analyzing”, “saving”, “storing”, “scanning”, “monitoring”, “obtaining”, “accessing”, “providing”, “facilitating”, “generating”, “displaying” or the like, refer to the action and processes of a computing system, or similar electronic computing device, that manipulates and transforms data represented as physical (electronic) quantities within the computing system's registers and memories into other data similarly represented as physical quantities within the computing system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a non-transitory machine readable storage medium, such as, but not limited to, any type of disk including floppy disks, optical disks, magnetic-optical disks, ROMs, compact disk ROMs (CD-ROMs), RAMs, erasable programmable ROMs (EPROMs), electrically EPROMs (EEPROMs), magnetic or optical cards, or any type of media suitable for storing electronic instructions, each coupled to a computing system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, the present invention is not described with reference to any particular programming language. It will be appreciated that a variety of programming languages may be used to implement the teachings of the invention as described herein.

The present invention may be provided as a computer program product, or software, that may include a non-transitory machine-readable medium having stored thereon instructions, which may be used to program a computing system (or other electronic devices) to perform a process according to the present invention. A machine-readable medium includes any mechanism for storing or transmitting information in a form readable by a machine (e.g., a computer). For example, a non-transitory machine-readable (e.g., computer-readable) medium includes a machine (e.g., a computer) readable storage medium (e.g., ROM, RAM, magnetic disk storage media, optical storage media, flash memory devices, etc.), a non-transitory machine (e.g., computer) readable transmission medium (non-propagating electrical, optical, or acoustical signals), etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as the invention.

What is claimed is:

1. A computer-implemented method comprising:
obtaining a binary file relating to a software package of an operating system;
extracting, from the binary file, interface details relating to interfaces associated with the software program, wherein the interfaces include application binary interfaces (ABIs);
receiving a user query requesting query-specific interface details that are particular to an interface of the interfaces noted in the user query;
extracting the query-specific interface details from the interface details; and
generating a response to the user query, wherein the response includes the query-specific interface details.

2. The computer-implemented method of claim 1, wherein the interfaces further include application programming interfaces (APIs).

3. The computer-implemented method of claim 1, further comprising:
sorting the interface details based on a predetermined sort pattern or according to a user request contained within the user query; and
storing the sorted interface details at a database.

4. The computer-implemented method of claim 1, wherein the user query is received from a user via a computing system over a network, wherein the response is provided back to the user via the computing system.

5. The computer-implemented method of claim 3, wherein the interface details comprises at least one of interface usage details, interface provisioning details, or interface metadata, wherein the interface usage details are based, at least in part, on a frequency at which each interface is accessed or used by a software package.

6. The computer-implemented method of claim 1, wherein the interfaces correspond to library functions associated with shared libraries of the software packages, wherein the library functions relate to one or more of file accesses, networking capabilities, user interface functions, thread management, process management, and common utilities.

7. The computer-implemented method of claim 6, further comprising correcting, at a provider, one or more errors associated with the interface based on the query-specific interface details, and adding one or more new interfaces based on the query-specific interface details.

8. The computer-implemented method of claim 1, further comprising displaying, via a display device, the response using at least one of Portable Document Format (PDF), Open Document Format (ODF), text format, or graphic format.

9. A system comprising:
a host computing device having a memory to store instructions for efficiently querying interface-related information, and a processing device to execute the instructions, wherein the instructions cause the processing device to:
obtain a binary file relating to a software package of an operating system;
extract, from the binary file, interface details relating to interfaces associated with the software program, wherein the interfaces include application binary interfaces (ABIs);
receive a user query requesting query-specific interface details that are particular to an interface of the interfaces noted in the user query;
extract the query-specific interface details from the interface details; and
generate a response to the user query, wherein the response includes the query-specific interface details.

10. The system of claim 9, wherein the interfaces further include application programming interfaces (APIs).

11. The system of claim 9, wherein the processing device is further to:
sort the interface details based on a predetermined sort pattern or according to a user request contained within the user query; and
store the sorted interface details at a database.

12. The system of claim 9, wherein the user query is received from a user via a computing system over a network, wherein the response is provided back to the user via the computing system.

13. The system of claim 11, wherein the interface details comprises at least one of interface usage details, interface provisioning details, or interface metadata, wherein the interface usage details are based, at least in part, on a frequency at which each interface is accessed or used by a software package.

14. The system of claim 9, wherein the interfaces correspond to library functions associated with shared libraries of the software packages, wherein the library functions relate to one or more of file accesses, networking capabilities, user interface functions, thread management, process management, and common utilities.

15. A non-transitory machine-readable medium including instructions that, when executed by a processing device, cause the processing device to perform a method, the method comprising:
obtaining a binary file relating to a software package of an operating system;
extracting, from the binary file, interface details relating to interfaces associated with the software program, wherein the interfaces include application binary interfaces (ABIs);
receiving a user query requesting query-specific interface details that are particular to an interface of the interfaces noted in the user query;
extracting the query-specific interface details from the interface details; and
generating a response to the user query, wherein the response includes the query-specific interface details.

16. The non-transitory machine-readable medium of claim 15, wherein the interfaces further include application programming interfaces (APIs).

17. The non-transitory machine-readable medium of claim 15, wherein the method further comprises:
sorting the interface details based on a predetermined sort pattern or according to a user request contained within the user query; and
storing the sorted interface details at a database.

18. The non-transitory machine-readable medium of claim 15, wherein the user query is received from a user via a computing system over a network, wherein the response is provided back to the user via the computing system.

19. The non-transitory machine-readable medium of claim 17, wherein the interface details comprises at least one of interface usage details, interface provisioning details, or interface metadata, wherein the interface usage details are based, at least in part, on a frequency at which each interface is accessed or used by a software package.

20. The non-transitory machine-readable medium of claim 15, wherein the interfaces correspond to library functions associated with shared libraries of the software packages, wherein the library functions relate to one or more of file accesses, networking capabilities, user interface functions, thread management, process management, and common utilities.
